(19) United States
(12) Patent Application Publication
(10) Pub. No.: US 2018/0330124 A1
(43) Pub. Date: Nov. 15, 2018

(54) FUNCTION CIRCUIT ENABLING METHOD AND CHIP USING THE SAME

(71) Applicant: MStar Semiconductor, Inc., Hsinchu Hsien (TW)

(72) Inventors: Chia-Cho WU, Hsinchu Hsien (TW); Robert John SMART, Hsinchu Hsien (TW)

(21) Appl. No.: 15/969,905

(22) Filed: May 3, 2018

Related U.S. Application Data
(60) Provisional application No. 62/505,127, filed on May 12, 2017.

(51) Int. Cl. G06F 21/71; G06F 21/73

(52) U.S. Cl. CPC G06F 21/71; G06F 21/73

(57) ABSTRACT

A function chip enabling method and a chip using the same. The function circuit enabling method is applicable to a chip including a function circuit, and includes steps of: receiving an enabling code, performing an operation on the enabling code according to a first key of a non-symmetric operation to generate a decrypted enabling code; comparing the decrypted enabling code with a predetermined enabling code to generate an enable signal to enable the function circuit. A second key corresponding to the first key of the non-symmetric operation is not stored in the chip.

This application claims the benefit of U.S. provisional application Ser. No. 62/505,127, filed May 12, 2017, the subject matter of which is incorporated herein by reference.

### BACKGROUND OF THE INVENTION

### Field of the Invention

The invention relates to an operation method and a chip using the method, and more particularly to a function circuit enabling method and a chip using the method.

### Description of the Related Art

Various innovated chips are provided one after another along with the development of electronics technologies. A chip can be equipped with function circuits to implement numerous functions. FIG. 1 shows a block diagram of a chip 900 of the prior art. The chip 900 includes a comparing unit 920 and a function circuit 930. To reinforce the security of the chip 900, the chip 900 may limit the activation of the function circuit 930 through an encryption technology. For example, the chip 900 may be pre-stored with a predetermined enabling code C99. When the chip 900 receives an enabling code C90, the comparing unit 920 compares the enabling code C90 with the predetermined enabling code C99, and outputs an enable signal S91 only when the enabling code C90 is consistent with the predetermined enabling code C99, so as to enable the function circuit 930.

However, the predetermined enabling code C99 stored in the chip 900 may be captured through a memory searching technique. Therefore, how to further reinforce the security of the chip 900 is one critical research and development goal.

### SUMMARY OF THE INVENTION

The invention is directed to a circuit enabling method and a chip using the method that enhance security of a chip through a non-symmetric encryption/decryption technology.

According to a first aspect of the present invention, a function circuit enabling method is provided. The function circuit enabling method is applicable to a chip including a function circuit, and includes steps of: receiving an enabling code; performing an operation on the enabling code according to a first key of a non-symmetric operation to generate a decrypted enabling code; comparing the decrypted enabling code with a predetermined enabling code to generate an enable signal to enable the function circuit. A second key corresponding to the first key of the non-symmetric operation is not stored in the chip.

According to a second aspect of the present invention, a chip is provided. The chip includes a function circuit, a non-symmetric operation unit and a comparing unit. The non-symmetric operation unit performs an operation on an enabling code to generate a decrypted enabling code. The comparing unit compares the decrypted enabling code with a predetermined enabling code to generate an enable signal to enable the function circuit. A second key corresponding to the first key of the non-symmetric operation is not stored in the chip.

The above and other aspects of the invention will become better understood with regard to the following detailed description of non-limiting embodiments. The following description is made with reference to the accompanying drawings.

### BRIEF DESCRIPTION OF THE DRAWINGS

FIG. 1 (prior art) is a block diagram of a chip of the prior art;

FIG. 2 is a block diagram of a chip according to an embodiment of the present i invention;

FIG. 3 is a flowchart of a function circuit enabling method according to an embodiment of the present invention;

FIG. 4A is a schematic diagram of a non-symmetric operation unit;

FIG. 4B is a flowchart of an operation method of the non-symmetric operation unit in FIG. 4A; and

FIG. 5 is a block diagram of a chip according to another embodiment of the present invention.

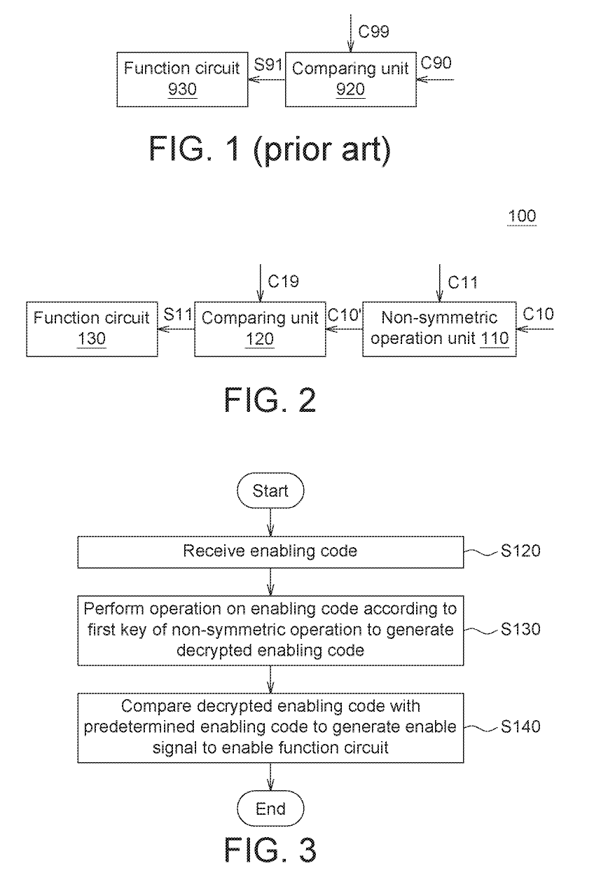

### DETAILED DESCRIPTION OF THE INVENTION

FIG. 2 shows a block diagram of a chip 100 according to an embodiment of the present invention. The chip 100 includes a non-symmetric operation unit 110, a comparing unit 120 and a function circuit 130. The non-symmetric operation unit 110 and the comparing circuit 120 are, for example, a circuit, firmware or multiple codes. The function circuit 130 is, for example, an image processing circuit or a wireless signal processing circuit. FIG. 3 is a flowchart of a function circuit enabling method according to an embodiment of the present invention. Operation details of the chip 100 are given with reference to FIG. 3 below.

The non-symmetric operation circuit 110 first receives an enabling code C10 (step S120), which is not stored in the chip 100. For example, the non-symmetric operation unit 110 may receive the enabling code C10 through a network interface of an electronic device where the chip 100 is located, or may read the enabling code C10 from other hardware circuits of the electronic device where the chip 100 is located. Next, the non-symmetric operation unit 110 performs an operation on the enabling code C10 according to a first key C11 of a non-symmetric operation to generate a decrypted enabling code C10′ (step S130). The comparing unit 120 then receives the decrypted enabling code C10′ from the non-symmetric operation unit 110, and compares the decrypted enabling code C10′ with a predetermined enabling code C19. When the decrypted enabling code C10′ is consistent with the predetermined enabling code C19, the comparing unit 120 outputs an enable signal S11 to enable the function circuit 130 (step S140). When the decrypted enabling code C10′ is inconsistent with the predetermined enabling code C19, the comparing unit 120 does not output the enable signal S11 so as to keep the function circuit 130 disabled. The first key C11 and the predetermined enabling code C19 are stored in the chip 100, for example, directly welded on the chip or stored in a non-volatile memory such as a read-only memory (ROM), a flash, an e-fuse or a one-time programmable (OTP) memory.

It should be noted that, the enabling code C10 is obtained by encrypting the predetermined enabling code C19, outside the chip 100, by using a second key (not shown) corresponding to the first key C11 of the non-symmetric operation, and the enabling code C10 is kept by an authorized user of the chip 100. Because the second key is not stored in the chip 100, even if an attacker cracks the chip 100 and obtains the first key C11 and the predetermined enabling code C19 stored therein, the enabling code C10 for enabling the function circuit 130 cannot be acquired without the second key. Thus, the security of the chip 100 is significantly enhanced.

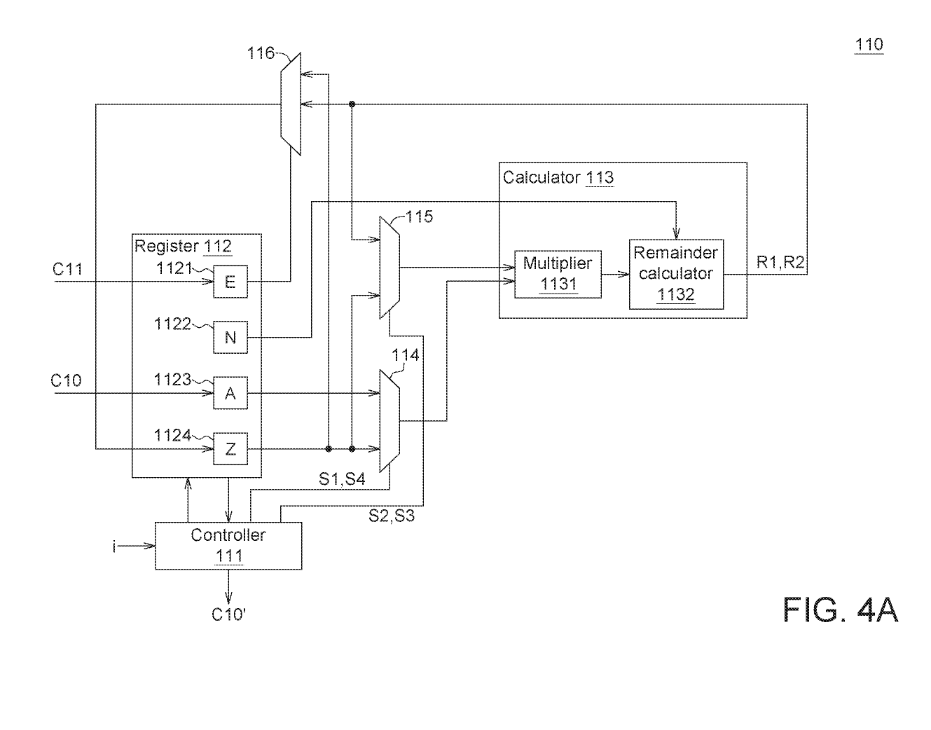

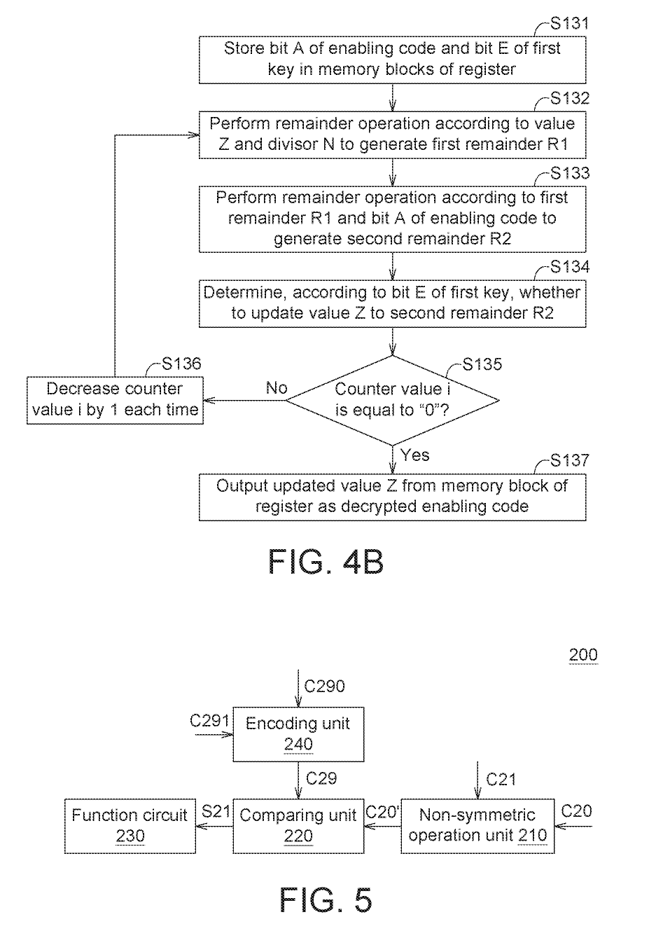

In one embodiment, the non-symmetric operation circuit 110 performs, for example, an operation on the enabling code C10 and the first key C11 by using a Rivest-Shamir-Adleman (RSA) algorithm to generate the decrypted enabling code C10′. For example, referring to FIG. 4A and FIG. 4B, FIG. 4A shows a block diagram of the non-symmetric operation unit 110 according to an embodiment, and FIG. 4B shows a flowchart of an operation method of the non-symmetric operation unit 110. The non-symmetric operation unit 110 includes a controller 111, a register 112, a calculator 113 and multiple multiplexers 114, 115 and 116. The controller 111 controls outputs of the register 112 and the calculator 113. The calculator 113 performs multiplication and remainder operations, and includes a multiplier 1131 and a remainder calculator 1132. After the enabling code C10, the first key C11 and a divisor N are inputted into the register 112, the controller 111 controls the calculator 113 to perform the multiplication and remainder operations. The non-symmetric operation unit 110 eventually outputs the decrypted enabling code C10′.

A bit A of the enabling code C10 and a bit E of the first key C11 are first respectively stored in memory blocks 1123 and 1121 (step S131) of the register 112.

The calculator 113 performs a remainder operation according to a value Z and a divisor N to generate a first remainder R1 (step S132). More specifically, the value Z is initially set to 1 by the controller 111 and is stored in a memory block 1124 of the register 112; the divisor N is a predetermined value stored in a memory block 1222 of the register 122. The controller 111 controls, according to a control signal 51, the multiplexer 114 to forward the value Z to the calculator 113, and controls, according to another control signal S2, another multiplexer 115 to forward the value Z to the calculator 113. The multiplier 1131 in the calculator 113 multiplies the two to obtain Z*Z. The remainder calculator 1132 in the calculator 113 receives Z*Z from the multiplier 1131, receives the divisor N from the memory block 1122 of the register 112, and performs calculation of (Z*Z)mod N to obtain a first remainder R1, i.e., R1=(Z*Z)mod N.

Next, the calculator 113 performs a remainder operation according to the first remainder R1 and the bit A the enabling code C10 to generate a second remainder R2 (step S133). More specifically, the controller 111 controls, according to a control signal S3, the multiplexer 115 to forward the first remainder R1 to the calculator 113, and controls, according to another control signal S4, the multiplexer 114 to forward the bit A of the enabling code C10 to the calculator 113. The multiplier 1131 in the calculator 113 multiplies the first remainder R1 by the bit A to obtain R1*A. The remainder calculator 1132 in the calculator 113 receives R1*A from the multiplier 1131, receives the divisor N from the memory block 1122 of the register 112, and performs calculation of (R1*A)mod N to obtain a second remainder R2, i.e., R2 (R1*A)mod N.

The multiplexer 116 determines, according to the bit E of the first key C11, whether to update the value Z to the second remainder R2 (step S134). More specifically, when the bit E is “1”, the multiplexer 116 outputs the second remainder R2 to the memory block 1124 to update the value Z to the second remainder R2; when the bit E is “0”, the multiplexer 116 outputs the original value Z in the memory block 1124 to the memory block 1124 of the register 112, that is, the updated value Z is kept unchanged.

The controller 111 eventually determines whether to output the decrypted enabling code C10′ according to a counter value i. More specifically, the counter value i is initially set as the length of the first key C11 subtracted by 1; if the counter value i is equal to “0” (step S135), the controller 111 outputs the updated value Z from the memory block 1124 of the register 112 as the decrypted enabling code C10′ (step S137); if the counter value i is not equal to “0” (step S135), the controller 111 decreases the counter value i by 1 each time (step S136), and repeats steps S132 to S135 according to the updated value Z, until the decrypted enabling code C10 is outputted.

FIG. 5 shows a block diagram of a chip 200 according to another embodiment of the present invention. Compared to the chip 100, in addition to a non-symmetric operation unit 210, a comparing unit 220 and a function circuit 230, the chip 200 further includes an encoding unit 240. In this embodiment, a predetermined enabling code C29 is generated based on a predetermined original code C290 and an identity code C291 by the encoding unit 240. For example, the encoding unit 240 may perform a one-way hash function on the predetermined original code C290 and the identity code C291 to generate the predetermined enabling code C29. The predetermined original code C290 and the identity code C291 may be directly burned in the chip 100 or stored in a non-volatile memory. For example, the non-volatile memory is a read-only memory (ROM), a flash, an e-fuse or a one-time programmable (OPT) memory.

In this embodiment, the enabling code C20 is generated outside the chip 200 by first performing the one-way hash function on the predetermined original code C290 and the identity code C291 to generate the predetermined enabling code C29, and then encrypting the predetermined enabling code C29 by using a second key (not shown) corresponding to the first key C21 of a non-symmetric operation. The enabling code C20 is then forwarded to and kept by an authorized user of the chip 200. Similarly, because the second key is not stored in the chip 200, even if an attacker cracks the chip and obtains the first key C21 and the predetermined enabling code C29 in the chip 200, the enabling code C20 for enabling the function circuit remains unobtainable without the second key. Thus, the security of the chip 200 is significantly enhanced.

In another embodiment, the encoding unit 240 of the chip 200 may generate, based on the predetermined original code C290 and different identity codes S291, different predetermined enabling codes S29, which may correspond to different circuit units or circuit combinations in the function circuit 230. Thus, the chip 200 may enable different functions or function combinations in the function chip 230 through different enabling codes C20. As such, without having to develop different chips for different functions, the same chip can be equipped with numerous functions, different enabling codes can be provided according to different solutions purchased by clients, and clients can activate corresponding functions according to the enabling codes acquired, thus significantly reducing production costs.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A function circuit enabling method, applicable to a chip comprising a function circuit, the function circuit enabling method comprising:
receiving an enabling code;
performing an operation on the enabling code according to a first key of a non-symmetric operation to generate a decrypted enabling code; and
comparing the decrypted enabling code with a predetermined enabling code to generate an enable signal to enable the function circuit;
wherein, a second key corresponding to the first key of the non-symmetric operation is not stored in the chip.

2. The function circuit enabling method according to claim 1, wherein the predetermined enabling code is not stored in the chip.

3. The function circuit enabling method according to claim 1, wherein the step of comparing the decrypted enabling code with the predetermined enabling code to generate the enable signal to enable the function circuit comprises:
outputting the enable signal when the decrypted enabling code is consistent with the predetermined enabling code.

4. The function circuit enabling method according to claim 1, wherein the step of comparing the decrypted enabling code with the predetermined enabling code to generate the enable signal to enable the function circuit comprises:
outputting a disable signal when the decrypted enabling code is inconsistent with the predetermined enabling code.

5. The function circuit enabling method according to claim 1, further comprising:
generating the predetermined enabling code according to an identity code.

6. A chip, comprising:
a function circuit;
a non-symmetric operation unit, performing an operation on an enabling code according to a first key of a non-symmetric operation to generate a decrypted enabling code; and
a comparing unit, comparing the decrypted enabling code with a predetermined enabling code to generate an enable signal to enable the function circuit;
wherein, a second key corresponding to the first key of the non-symmetric operation is not stored in the chip.

7. The chip according to claim 6, wherein the predetermined enabling code is not in stored in the chip.

8. The chip according to claim 6, wherein the comparing unit outputs the enable signal when the decrypted enabling signal is consistent with the predetermined enabling code.

9. The chip according to claim 6, wherein the comparing unit outputs a disable signal when the decrypted enabling signal is inconsistent with the predetermined enabling code.

10. The chip according to claim 6, further comprising:
an encoding unit, generating the predetermined enabling code according to an identity code.
